(19) United States
(12) Patent Application Publication
(10) Pub. No.: US 2020/0178528 A1
(43) Pub. Date: Jun. 11, 2020

(54) SAFENING AMINOPYRALID COMPOSITIONS IN BRASSICA SPECIES WITH CLOPYRALID AND METHODS OF USE THEREOF

(71) Applicant: Dow AgroSciences LLC, Indianapolis, IN (US)

(72) Inventors: Bernard M. Harris, New Plymouth (NZ); Shelley Bath, Otane (NZ); Rory Degenhardt, Edmonton (CA)

(73) Assignee: Dow AgroSciences LLC, Indianapolis, IN (US)

(21) Appl. No.: 16/212,737

(22) Filed: Dec. 7, 2018

(51) Int. Cl. A01N 43/40

(52) U.S. Cl. CPC A01N 43/40

(57) ABSTRACT

Provided herein are safened herbicidal compositions for use in Brassica species susceptible to injury by aminopyralid comprising (a) a herbicidally effective amount of aminopyralid or an agriculturally acceptable salt or ester of thereof, and (b) clopyralid or an agriculturally acceptable salt, ester, or combination thereof.

This application is a divisional application of U.S. patent application Ser. No. 15/611,956 filed on Jun. 2, 2017, which claims priority to provisional application 62/348,498 which was filed in the U.S. Patent and Trademark Office on Jun. 10, 2016, the entire disclosure of which is hereby incorporated by reference.

### BACKGROUND

The protection of Brassica species from weeds and other vegetation which inhibit the growth and yield of the Brassica species is a constantly recurring problem. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. Such herbicides, however, can injure the Brassica species in addition to the weeds and other vegetation intended to be controlled.

### SUMMARY

Provided herein are safened herbicidal compositions for use in Brassica species that are susceptible to injury by aminopyralid containing (a) a herbicidally effective amount of aminopyralid, an agriculturally acceptable salt or ester thereof, or combinations thereof and (b) clopyralid or agriculturally acceptable salts, esters, or combinations thereof. The compositions may also contain one or more agriculturally acceptable adjuvants or carriers and additional inert ingredients.

Provided herein also are methods for safening Brassica species susceptible to injury from aminopyralid including applying to the Brassica species, contacting the vegetation, or area adjacent thereto with a herbicidal composition comprising (a) a herbicidally effective amount of aminopyralid, an agriculturally acceptable salt or ester thereof, or combinations thereof and (b) clopyralid or agriculturally acceptable salts, esters, or combinations thereof.

The Brassica species susceptible to injury from aminopyralid or an agriculturally acceptable salt or ester thereof that can be safened using the compositions and methods described herein include, but are not limited to, stem kale (Brassica oleracea var. acephala subvar. Medullosa, BRSOM), spring rape or Spring Argentine rape, Roundup® Ready (Brassica napus, BRSNS-RR), and Aparima Gold swede (Brassica sp., BRSSS).

### DETAILED DESCRIPTION

Surprisingly, it has been found that aminopyralid, which is normally injurious to Brassica crops, can be made to cause reduced injury to the Brassica crops while still providing excellent control of unwanted vegetation by co-applying clopyralid.

### I. Definitions

As used herein, aminopyralid is 4-amino-3,6-dichloro-2-pyridinecarboxylic acid, which has the following structure:

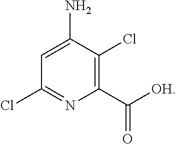 [SMILES: Nc1cc(Cl)nc(C(=O)O)c1Cl]

Exemplary uses of aminopyralid include, but are not limited to, its use for long-term control of annual and perennial broadleaf weeds, e.g., in range and pasture. Exemplary chemical forms of aminopyralid include, but are not limited to, for example, aminopyralid TIPA, which is tris (2-hydroxypropyl)ammonium 4-amino-3,6-dichloropyridine-2-carboxylate and has the following structure:

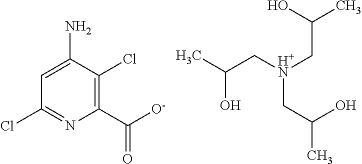

and aminopyralid-potassium, which is potassium 4-amino-3,6-dichloropyridine-2-carboxylate and has the following structure:

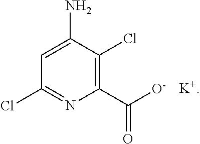

As used herein, clopyralid is 3,6-dichloro-2-pyridinecarboxylic acid, which has the following structure:

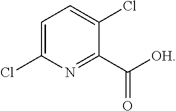 [SMILES: O=C(O)c1nc(Cl)ccc1Cl]

Exemplary uses of clopyralid include, but are not limited to, post-emergence control of many annual and perennial broadleaf weeds, e.g., in sugar beet, fodder beet, oilseed rape, maize, cereals, brassicas, onions, leeks, strawberries and flax, and in grassland and non-crop land. Exemplary chemical forms of clopyralid include, but are not limited to, for example, clopyralid MEA or clopyralid olamine, which is 2-hydroxyethanaminium 3,6-dichloro-2-pyridinecarboxylate and has the following structure:

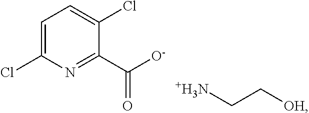

and clopyralid-triisopropanolammonium, which is (2RS,2′RS,2″RS)-tris(2-hydroxypropyl)ammonium 3,6-dichloropyridine-2-carboxylate and has the following structure:

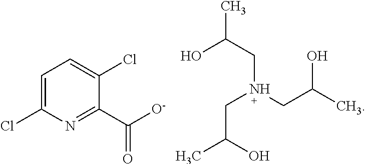

As used herein, herbicide means an active ingredient that kills, controls, or otherwise adversely modifies the growth of plants.

As used herein, a Brassica species susceptible to injury from aminopyralid is a Brassica species that upon contact with aminopyralid or an agriculturally acceptable salt or ester thereof experiences an adversely modifying effect such as, but not limited to, deviations from natural development, growth regulation, desiccation, growth retardation, plant death, and the like.

As used herein, plants and vegetation include, but are not limited to, dormant seeds, germinant seeds, emerging seedlings, plants emerging from vegetative propagules, immature vegetation, mature vegetation, and established vegetation.

As used herein, immature vegetation refers to small vegetative plants prior to reproductive stage, and mature vegetation refers to vegetative plants during and after reproductive stage.

Brassica species to be protected from the adverse effects of undesirable plant growth may be damaged to a certain degree when an effective dose of a herbicide is used. Safening, as used herein, means preventing or reducing the adverse effect of a herbicide on the Brassica species, i.e., protecting the Brassica species without, at the same time, noticeably influencing (i.e., overly diminishing) the herbicidal action on the undesirable plant growth, i.e., weeds, to be controlled.

Brassica species susceptible to injury from aminopyralid or an agriculturally acceptable salt or ester thereof include, but are not limited to, all varieties of canola and oilseed rape (Brassica napus, BRSNN), forage brassica, garden brassica and seed producing brassica, including spring rape or Spring Argentine canola (Brassica napus, BRSNS), winter oilseed rape (Brassica napus, BRSNW), Roundup Ready® canola (Brassica napus, RR-BRSNN), Nexera™ canola (Brassica napus, BRSNN-NEX), stem kale (Brassica oleracea var. acephala subvar. medullosa, BRSOM), Aparima Gold swede (Brassica sp., BRSSS), rutabaga (Brassica napus var. napobrassica, BRSNA), turnip or Polish canola (Brassica rapa,

BRSRR), kale/Chinese kale (Brassica alboglabra, BRSAG), Juncea canola or brown mustard (Brassica juncea, BRSJU), broccoli/cauliflower (Brassica oleracea [botrytis], BRSOK), cabbage (Brassica oleracea [capitata], BRSOL), Abyssinian mustard (Brassica carinata, BRSCA), yellow mustard (Sinapis alba, SINAL) and Gold-of-Pleasure (Camelina sativa, CMASA).

As used herein, agriculturally acceptable salts and esters refer to salts and esters that exhibit herbicidal activity or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending upon the pH, may be in the dissociated or undissociated form. Exemplary salts include those derived from alkali or alkaline earth metals and those derived from ammonia and amines Exemplary cations include sodium, potassium, magnesium, and aminium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment of the corresponding herbicidal carboxylic acid with a metal hydroxide, such as, for example, sodium hydroxide, with ammonia, with an amine, such as, for example, dimethylamine, trimethylamine, diethanolamine, 2-methyl-thiopropylamine, bisallylamine, 2-butoxyethylamine, morpholine, cyclododecylamine, or benzylamine or with a tetraalkylammonium hydroxide, such as, for example, tetramethylammonium hydroxide or choline hydroxide.

Exemplary esters include those derived from C₁-C₁₂ alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, 2-octanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

### II. Compositions

Provided herein are safened herbicidal compositions for use in Brassica species susceptible to injury by aminopyralid containing: (a) an herbicidally effective amount of aminopyralid or an agriculturally acceptable salt or ester thereof, or combinations thereof, and (b) clopyralid or agriculturally acceptable salts, esters, or combinations thereof, which safens the aminopyralid to the Brassica species. The described compositions may also contain an agriculturally acceptable adjuvant or carrier and additional inert ingredients.

In some embodiments, the compositions and methods described herein may include aminopyralid and the compatible herbicide is clopyralid-olamine

In some embodiments, the compositions and methods described herein may include aminopyralid and the compatible herbicide is clopyralid-triisopropanolammonium (TIPA).

In some embodiments, the compositions and methods described herein may include aminopyralid-TIPA and the compatible herbicide is clopyralid.

In some embodiments, the compositions and methods described herein may include aminopyralid-TIPA the compatible herbicide is clopyralid-olamine

In some embodiments, the compositions and methods described herein may include aminopyralid-TIPA the compatible herbicide is clopyralid-TIPA.

In the compositions and methods described herein, an agriculturally acceptable ester or salt of aminopyralid is employed. An agriculturally acceptable ester, such as an aralkyl or alkyl ester, can be employed. The ester can be a C₁-C₄ alkyl ester, a methyl ester, a n-butyl ester, a benzyl ester, or a substituted benzyl ester. Additionally, the carboxylic acid form or the carboxylate salt of the aminopyralid may be used.

In the compositions and methods described herein, the aminopyralid or a salt or ester thereof is used in combination with clopyralid or agriculturally acceptable salts, esters, or combinations thereof. The weight ratio of the aminopyralid or a salt or ester thereof to the clopyralid or agriculturally acceptable salts, esters, or combinations thereof is within the range of from 1:224 to 16.7:1. The weight ratio of the aminopyralid or a salt or ester thereof, to clopyralid or agriculturally acceptable salts, esters, or combinations thereof can also be within the range from 1:220 to 16.7:1, 1:200 to 16.7:1, 1:180 to 16.7:1, 1:160 to 16.7:1, 1:150 to 16.7:1, 1:140 to 16.7:1, 1:130 to 16.7:1, 1:120 to 16.7:1, 1:100 to 16.7:1, 1:80 to 16.7:1, 1:60 to 16.7:1, 1:40 to 16.7:1, 1:30 to 16.7:1, 1:20 to 16.7:1, 1:18 to 16.7:1, 1:16 to 16.7:1, 1:14 to 16.7:1, 1:12 to 16.7:1, 1:10 to 16.7:1, 1:8 to 16.7:1, 1:6 to 16.7:1, 1:5 to 16.7:1, 1:4 to 16.7:1, 1:3 to 16.7:1, 1:2 to 16.7:1, 1:1 to 16.7:1, 1:224 to 15:1, 1:200 to 14:1, 1:175 to 12:1, 1:150 to 10:1, 1:125 to 9:1, 1:100 to 8:1, 1:90 to 6.7:1, 1:80 to 7:1, 1:70 to 6.5:1, 1:60 to 6.4:1, 1:50 to 6.2:1, 1:40 to 6:1, 1:30 to 5.8:1, 1:20 to 5.6:1, 1:25 to 5.4:1, 1:20 to 5.2:1, 1:18 to 5:1, 1:15 to 4.8:1, 1:12 to 4.6:1, 1:11 to 4.4:1, 1:10 to 4.2:1, 1:9 to 4:1, 1:8.5 to 3.8:1, 1:8 to 3.6:1, 1:7.5 to 3.4:1, 1:7 to 3.2:1, 1:6.5 to 3:1, 1:6 to 2.7:1, 1:4 to 1:1, 1:3 to 1:1, or 1:2 to 1:1. Additionally, the weight ratio of the aminopyralid or a salt or ester thereof to clopyralid or agriculturally acceptable salts, esters, or combinations thereof can be 16.7:1, 14:1, 12:1, 10:1, 9:1, 8:1, 7:1, 6:1, 5:1, 4:1, 3:1, 2.7:1, 2:1, 1.8:1, 1.6:1, 1.5:1, 1.4:1, 1.3:1, 1.2:1, 1.1:1, 1:1, 1:1.1, 1:1.2, 1:1.3, 1:1.4, 1:1.5, 1:1.6, 1:1.8, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, 1:3.9, 1:4, 1:4.1, 1:4.2, 1:4.3, 1:4.4, 1:4.5, 1:4.6, 1:4.7, 1:4.8, 1:4.9, 1:5, 1:6, 1:7, 1:8, 1:9, 1:10, 1:11, 1:12, 1:13, 1:14, 1:15, 1:16, 1:18, 1:20, 1:25, 1:30, 1:36, 1:40, 1:45, 1:50, 1:60, 1:75, 1:90, 1:100, 1:125, 1:150, 1:175, 1:200 or 1:224.

The safened compositions can further, be used in conjunction with 5-enolpyruvylshikimate-3-phosphate (EPSP) synthase inhibitors (e.g., glyphosate), glutamine synthetase inhibitors (e.g., glufosinate), synthetic auxins (e.g., dicamba, phenoxy auxins, pyridyloxy auxins), auxin transport inhibitors, acetyl CoA carboxylase (ACCase) inhibitors (e.g., aryloxyphenoxypropionates, cyclohexanediones, phenylpyrazolines), acetolactate synthase (ALS) or acetohydroxy acid synthase (AHAS) inhibitors (e.g., imidazolinones, sulfonylureas, pyrimidinylthiobenzoates, triazolopyrimidines, sulfonylaminocarbonyltriazolinones), 4-hydroxyphenyl-pyruvate dioxygenase (HPPD) inhibitors, phytoene desaturase inhibitors, carotenoid biosynthesis inhibitors, protoporphyrinogen oxidase (PPO) inhibitors, cellulose biosynthesis inhibitors, mitosis inhibitors, microtubule inhibitors, very long chain fatty acid inhibitors, fatty acid and lipid biosynthesis inhibitors, photosystem I inhibitors, and photosystem II inhibitors (e.g., triazines and bromoxynil).

The safened herbicide mixtures described herein can be applied in conjunction with one or more other herbicides to control a wider variety of undesirable vegetation. When used in conjunction with other herbicides, the composition can be formulated with the other herbicide or herbicides, tank mixed with the other herbicide or herbicides, or applied sequentially with the other herbicide or herbicides. Some of the herbicides that can be employed in conjunction with the compositions and methods described herein include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, alachlor, allidochlor, alloxydim, alorac, ametridione, ametryn, amibuzin, amicarbazone, amidosulfuron, aminocyclopyrachlor, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl +isoxadifen-ethyl, fenoxasulfone, fenquinotrione, fenteracol, fenthiaprop, fentrazamide, fenuron, flamprop, flamprop-M, flazasulfuron, florasulam, florpyrauxifen, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate salts and esters, glufosinate-ammonium, glufosinate-P-ammonium, glyphosate salts and esters, halauxifen, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lancotrione, lactofen, lenacil, linuron, MAA, MAMA, MCPA, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione- calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron, tribenuron-methyl, tricamba, triclopyr, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

In some embodiments, the compositions described herein are employed in combination with one or more plant growth regulators, such as 1-MCP, 2,3,5-tri-iodobenzoic acid, IAA, IBA, naphthaleneacetamide, a-naphthaleneacetic acids, benzyladenine, 4-hydroxyphenethyl alcohol, kinetin, zeatin, endothal, pentachlorophenol, thidiazuron, tribufos, aviglycine, ethephon, maleic hydrazide, gibberellins, gibberellic acid, abscisic acid, ancymidol, fosamine, glyphosine, isopyrimol, jasmonic acid, maleic hydrazide, mepiquat, morphactins, dichlorflurenol, flurprimidol, mefluidide, paclobutrazol, tetcyclacis, uniconazole, brassinolide, brassinolide-ethyl, cycloheximide, ethylene, methasulfocarb, prohexadione, triapenthenol, and trinexapac-ethyl. In some embodiments, the plant growth regulator is mixed with the aminopyralid to cause a preferentially advantageous effect on plants.

The compositions provided herein can further include one or more agriculturally acceptable adjuvant or carrier. Suitable adjuvants or carriers should not be phytotoxic to the Brassica species, particularly at the concentrations employed in applying the compositions for selective weed control in the presence of the Brassica species and should not react chemically with herbicidal components or other composition ingredients. Such mixtures can be designed for application directly to weeds or their locus or can be concentrates or formulations that are normally diluted with additional carriers and adjuvants before application. The adjuvants or carriers can be solids, such as, for example, dusts, granules, water-dispersible granules, or wettable powders, or liquids, such as, for example, emulsifiable concentrates, solutions, emulsions or suspensions. Additionally, the adjuvants or carriers can also be provided as a pre-mix or tank mixed.

Suitable agricultural adjuvants and carriers are well known to those of skill in the art and include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Examples of liquid carriers that can be used in the compositions and methods described herein include water and organic solvents. Examples of useful organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is useful as a carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

The compositions described herein may further include one or more surface-active agents. Such surface-active agents can be used in both solid and liquid compositions, and can be designed to be diluted with a carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corporation: Ridgewood, N.J., 1998 and in Encyclopedia of Surfactants, Vol. I-III, Chemical Publishing Company: New York, 1980-81. Surface-active agents include, but are not limited to salts of alkyl sulfates, such as diethanolammonium lauryl sulfate; alkylarylsulfonate salts, such as calcium dodecylbenzenesulfonate;

alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, e.g., methyl esters. These materials, such as vegetable or seed oils and their esters, can be used interchangeably as an agricultural adjuvant, as a liquid carrier or as a surface active agent.

Other additives useful in the compositions provided herein include, but are not limited to, compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The concentration of active ingredients in the compositions described herein is generally from 0.0005 to 98 percent by weight. Additionally, concentrations from 0.0006 to 90 percent by weight can be used. In compositions designed to be employed as concentrates, the active ingredients can be present in a concentration from 0.1 to 98 weight percent or from 0.5 to 90 weight percent. Such compositions can be diluted with an inert carrier, such as, for example, water, before application. The diluted compositions usually applied to vegetation or the soil adjacent thereto can contain from 0.0006 to 15.0 weight percent active ingredient or from 0.001 to 10.0 weight percent active ingredient.

### III. Methods of Use

Provided herein also are methods for safening Brassica species susceptible to injury from aminopyralid including applying to the Brassica species, contacting the vegetation, or area adjacent thereto with a herbicidal composition containing (a) a herbicidally effective amount of aminopyralid, an agriculturally acceptable salt or ester thereof, or combinations theroef and (b) clopyralid or agriculturally acceptable salts, esters, or combinations thereof.

Compositions for use in these methods are described herein above. The aminopyralid or an agriculturally acceptable salt or ester of thereof and clopyralid or agriculturally acceptable salts, esters, or combinations thereof, can be applied either separately or together as part of a system. When part of a system, for example, the aminopyralid or an agriculturally acceptable salt or ester of thereof and the clopyralid or agriculturally acceptable salts, esters, or combinations thereof as described herein, can be formulated in one composition, tank mixed, applied simultaneously, or applied sequentially. The aminopyralid or an agriculturally acceptable salt or ester of thereof and the clopyralid or agriculturally acceptable salts, esters, or combinations thereof as described herein, can be applied pre-emergently to the Brassica species or the undesirable vegetation or post-emergently to the Brassica species or the undesirable vegetation.

Herbicidal activity is exhibited by the aminopyralid or an agriculturally acceptable salt or ester of thereof, when it is applied directly to a plant or to the area adjacent to the plant at any stage of growth. The herbicidal activity observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. The compositions of aminopyralid described herein may be applied as a post-emergence application, or pre-emergence application, to relatively immature undesirable vegetation to achieve the maximum control of the undesirable vegetation.

The application rate will depend upon the particular type of weed to be controlled, the degree of control required, and the timing and method of application. In the compositions described herein the aminopyralid, or a salt or ester thereof, can be applied at an application rate of from 2.5 grams acid equivalent per hectare (g ae/ha) to 250 g ae/ha based on the total amount of the aminopyralid, or a salt or ester thereof, in the composition. Additionally, in the compositions described herein the aminopyralid, or a salt or ester thereof, can be applied at an application rate of from 2.5 g ae/ha to 240 g ae/ha, 5 g ae/ha to 230 g ae/ha, 2.5 g ae/ha to 220 g ae/ha, 5 g ae/ha to 200 g ae/ha, 10 g ae/ha to 200 g ae/ha, 12.5 g ae/ha to 150 g ae/ha, 12.5 g ae/ha to 200 g ae/ha, 2.5 g ae/ha to 150 g ae/ha, 2.5 g ae/ha to 125 g ae/ha, 2.5 g ae/ha to 120 g ae/ha, 2.5 g ae/ha to 110 g ae/ha, 2.5 g ae/ha to 100 g ae/ha, 2.5 g ae/ha to 95 g ae/ha, 2.5 g ae/ha to 90 g ae/ha, 2.5 g ae/ha to 85 g ae/ha, 5 g ae/ha to 150 g ae/ha, 5 g ae/ha to 100 g ae/ha, 5 g ae/ha to 80 g ae/ha, 5 g ae/ha to 75 g ae/ha, 10 g ae/ha to 150 g ae/ha, 10 g ae/ha to 125 g ae/ha, 10 g ae/ha to 100 g ae/ha, 10 g ae/ha to 85 g ae/ha, 10 g ae/ha to 75 g ae/ha, or 10 g ae/ha to 60 g ae/ha based on the total amount of the aminopyralid, or a salt or ester thereof, in the composition. In the compositions described herein the clopyralid or agriculturally acceptable salts, esters, or combinations thereof can be applied at an application rate of from 15 g ae/ha to 560 g ae/ha. Additionally, in the compositions described herein the clopyralid or agriculturally acceptable salts, esters, or combinations thereof can be applied at an application rate of from 15 g ae/ha to 500 g ae/ha, 15 g ae/ha to 475 g ae/ha, 15 g ae/ha to 450 g ae/ha, 15 g ae/ha to 425 g ae/ha, 15 g ae/ha to 400 g ae/ha, 15 g ae/ha to 390 g ae/ha, 15 g ae/ha to 380 g ae/ha, 15 g ae/ha to 370 g ae/ha, 15 g ae/ha to 360 g ae/ha, 18 g ae/ha to 560 g ae/ha, 18 g ae/ha to 500 g ae/ha, 18 g ae/ha to 475 g ae/ha, 18 g ae/ha to 450 g ae/ha, 18 g ae/ha to 425 g ae/ha, 18 g ae/ha to 400 g ae/ha, 18 g ae/ha to 390 g ae/ha, 18 g ae/ha to 380 g ae/ha, 18 g ae/ha to 370 g ae/ha, 18 g ae/ha to 360 g ae/ha, 20 g ae/ha to 560 g ae/ha, 20 g ae/ha to 500 g ae/ha, 20 g ae/ha to 475 g ae/ha, 20 g ae/ha to 450 g ae/ha, 20 g ae/ha to 425 g ae/ha, 20 g ae/ha to 400 g ae/ha, 20 g ae/ha to 390 g ae/ha, 20 g ae/ha to 380 g ae/ha, 20 g ae/ha to 370 g ae/ha, 20 g ae/ha to 360 g ae/ha, 22.5 g ae/ha to 560 g ae/ha, 22.5 g ae/ha to 500 g ae/ha, 22.5 g ae/ha to 475 g ae/ha, 22.5 g ae/ha to 450 g ae/ha, 22.5 g ae/ha to 425 g ae/ha, 22.5 g ae/ha to 400 g ae/ha, 22.5 g ae/ha to 390 g ae/ha, 22.5 g ae/ha to 380 g ae/ha, 22.5 g ae/ha to 370 g ae/ha, 360 g ae/ha to 560 g ae/ha, 370 g ae/ha to 560 g ae/ha, 380 g ae/ha to 560 g ae/ha, 390 g ae/ha to 560 g ae/ha, 400 g ae/ha to 560 g ae/ha, 425 g ae/ha to 560 g ae/ha, 450 g ae/ha to 560 g ae/ha, 475 g ae/ha to 560 g ae/ha, 500 g ae/ha to 560 g ae/ha, 515 g ae/ha to 560 g ae/ha, 525 g ae/ha to 560 g ae/ha, 15 g ae/ha to 22.5 g ae/ha, 16 g ae/ha to 22.5 g ae/ha, 17 g ae/ha to 22.5 g ae/ha, or 18 g ae/ha to 22.5 g ae/ha, based on the total amount of the clopyralid or agriculturally acceptable salts, esters, or combinations thereof. For example, the clopyralid or agriculturally acceptable salts, esters, or combinations thereof may be applied at a rate from 22.5 g ae/ha to 360 g ae/ha and the aminopyralid, or a salt or ester thereof, may be applied at a rate from 55 g ae/ha to 65 g ae/ha.

The components of the mixtures described herein can be applied either separately or as part of a multipart herbicidal system.

The compositions and methods provided herein can be used to control weeds in Brassica species, and also in 5-enolpyruvylshikimate-3-phosphate (EPSP) synthase inhibitor-tolerant (e.g., glyphosate-tolerant), glutamine synthetase inhibitor-tolerant (e.g., glufosinate-tolerant), synthetic auxin-tolerant (e.g., dicamba-tolerant, phenoxy auxin-tolerant, pyridyloxy auxin-tolerant), auxin transport inhibitor-tolerant, acetyl CoA carboxylase (ACCase) inhibitor-tolerant (e.g., aryloxyphenoxypropionate-tolerant), acetolactate synthase (ALS) or acetohydroxy acid synthase (AHAS) inhibitor-tolerant (e.g., imidazolinone-tolerant, sulfonylurea-tolerant, pyrimidinylthiobenzoate-tolerant, triazolopyrimidine-tolerant, sulfonylaminocarbonyltriazolinone-tolerant), 4-hydroxyphenyl-pyruvate dioxygenase (HPPD) inhibitor-tolerant, phytoene desaturase inhibitor-tolerant, carotenoid biosynthesis inhibitor-tolerant, protoporphyrinogen oxidase (PPO) inhibitor-tolerant, cellulose biosynthesis inhibitor-tolerant, mitosis inhibitor-tolerant, microtubule assembly inhibitor-tolerant, very long chain fatty acid inhibitor-tolerant, fatty acid and lipid biosynthesis inhibitor-tolerant, photosystem I inhibitor-tolerant, and photosystem II inhibitor-tolerant (e.g., triazine-tolerant and bromoxynil-tolerant) Brassica species. The compositions and methods provided herein can be applied to nursery Brassica species, pre-plant treatments and post-emergence treatments to Brassica species. The compositions and methods may be used in controlling undesirable vegetation in Brassica species genetically transformed to express specialized traits. Examples of specialized traits may include agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture). Additional examples include those expressing proteins toxic to invertebrate pests, such as Bacillus thuringiensis or other insecticidal toxins, or those with multiple or “stacked” foreign genes expressing insecticidal toxins, herbicide resistance, nutrition-enhancement and/or other beneficial traits, for example, grasses possessing multiple or stacked traits conferring tolerance to multiple chemistries and/or multiple modes of action via single and/or multiple resistance mechanisms.

The aminopyralid or a salt or ester thereof and the clopyralid or agriculturally acceptable salts, esters, or combinations thereof can be used in combination with herbicides that are selective to the Brassica species and which complement the spectrum of weeds controlled by the aminopyralid. The compositions described herein and the complementary herbicides can be applied at the same time, either as a combination formulation, as a tank mix or sequentially. The compositions and methods may be used in controlling undesirable vegetation in Brassica species possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

The present compositions can be applied to vegetation or the soil or water adjacent thereto by the use of conventional ground or aerial dusters, sprayers, and granule applicators, by addition to irrigation or paddy water, and by other conventional means known to those skilled in the art.

The following Examples are presented to illustrate various aspects of the compositions and methods described herein and should not be construed as limitations to the claims.

### EXAMPLES

Colby's equation was used to determine the herbicidal effects expected from the mixtures evaluated in the described trials (Colby, S. R. Calculation of the synergistic and antagonistic response of herbicide combinations. Weeds 1967, 15, 20-22.).

The following equation was used to calculate the expected activity of mixtures containing two active ingredients, A and B:

Expected=A+B−(A×B/100)

A=observed efficacy of active ingredient A at the same concentration as used in the mixture;

B=observed efficacy of active ingredient B at the same concentration as used in the mixture.

The compositions tested, application rates employed, plant species tested, and results are given in Table 1 through Table 5.

The following abbreviations are used in Tables 1 to 5:

BRSOM=Brassica oleracea var. acephala subvar. Medullosa (stem kale)

BRSSS=Brassica sp. (Aparima Gold swede)

BRSNS-RR=Brassica napus (spring rape or Spring Argentine rape, Roundup® Ready)

g ae/ha=grams acid equivalent per hectare

Mean % visual injury=observed value of percent (%) injury rated visually

Observed Mean % visual injury=observed value of percent (%) injury rated visually

Colby predicted mean % visual injury=expected value of percent (%) injury as calculated by Colby's equation

Mean % visual leafroll=observed value of percent (%) leafroll rated visually

Observed Mean % visual leafroll=observed value of percent (%) leafroll rated visually

Colby predicted mean % visual leafroll=expected value of percent (%) leafroll as calculated by Colby's equation

Mean % visual growth inhibition=observed value of percent (%) growth inhibition rated visually

Observed Mean % visual growth inhibition=observed value of percent (%) growth inhibition rated visually

Colby predicted mean % visual growth inhibition =expected value of percent (%) growth inhibition as calculated by Colby's equation

### Example 1. Evaluation of Postemergence Herbicidal Safening of Aminopyralid in Brassica Species

Two pot trials were established at Dow AgroSciences Waireka Field Research Station, New Zealand to evaluate crop safety of herbicide treatments to two species of leafy and bulb forage brassica crops (stem kale (Brassica oleracea var. acephala subvar. medullosa, BRSOM) and Aparima Gold swede (Brassica sp., BRSSS)). Trials were designed as randomized complete blocks with five replicates. Trials were established as weed-free tolerance trials. Pot size was 10 by 10 centimeters (cm, width×length). The forage brassica crops were grown using normal cultural practices for fertilization, seeding, watering and maintenance to ensure good growth of the crops.

All herbicide treatments were applied post-emergence with applications made to the crops at the 2 to 5-leaf stage. Herbicides were applied with a belt spray chamber system with compressed air as a propellant. The sprayer utilized a flat fan spray nozzle calibrated to deliver a uniform spray pattern that provided thorough coverage of the foliage using a 200 liters per hectare (L/ha) spray volume. All treatments were applied with Uptake adjuvant (paraffinic oil/Non-Ionic Surfactant blend) at 0.5% volume per volume (v/v). Phytotoxicity to the crops was assessed visually at several intervals after application as percent overall injury, compared to an untreated control plot. The overall injury assessments were based on visual ratings of growth inhibition, leaf deformity, epinasty, and chlorosis. All treatment results, both for the single product and mixtures, are an average of five replicates.

Herbicide Treatments

Aminopyralid-triisopropanolammonium (TIPA) was applied as Tordon™ Max

Herbicide (30 grams acid equivalent per liter (g ae/L) soluble (liquid) concentrate (SL)), and clopyralid-TIPA was applied as Versatill™ (300 g ae/L SL),

The compositions tested, application rates employed, plant species tested, and results are given in Table 1 through Table 3.

TABLE 1
Reduction in Percent (%) Visual Injury to BRSOM from Postemergence
Applications of Aminopyralid-triisopropanolammonium (TIPA) +
Clopyralid-triisopropanolammonium (TIPA) in Pot Trials.

| | | | | | | Aminopyralid TIPA + | |
|---|---|---|---|---|---|---|---|
| | | | | | | Clopyralid TIPA | |
| | | Aminopyralid | | Clopyralid | | | Colby |
| | | TIPA | | TIPA | | Observed | Predicted |
| Crop | | | Mean % | | Mean % | Mean % | Mean % |
| Bayer | Evaluation | g | Visual | g | Visual | Visual | Visual |
| Code | Interval | ae/ha | Injury | ae/ha | Injury | Injury | Injury |
| BRSOM | 7DAA1 | 60 | 6.2 | 90.0 | 0.0 | 0.6 | 6.2 |
| BRSOM | 15DAA1 | 60 | 4.6 | 90.0 | 0.0 | 2.6 | 4.6 |
| BRSOM | 28DAA1 | 60 | 23.4 | 90.0 | 0.0 | 12.4 | 23.4 |
| BRSOM | 7DAA1 | 60 | 22.5 | 180.0 | 0.0 | 6.7 | 22.5 |
| BRSOM | 7DAA1 | 60 | 22.5 | 360.0 | 0.0 | 4.2 | 22.5 |
| BRSOM | 7DAA1 | 60 | 22.5 | 45.0 | 0.0 | 7.5 | 22.5 |
| BRSOM | 7DAA1 | 60 | 4.6 | 180.0 | 0.7 | 2.6 | 5.3 |
| BRSOM | 7DAA1 | 60 | 4.6 | 360.0 | 0.7 | 2.0 | 5.3 |
| BRSOM | 7DAA1 | 60 | 4.6 | 45.0 | 0.7 | 2.8 | 5.3 |
| BRSOM | 7DAA1 | 60 | 4.6 | 90.0 | 0.7 | 3.6 | 5.4 |
| BRSOM | 15DAA1 | 60 | 39.2 | 180.0 | 0.0 | 8.3 | 39.2 |
| BRSOM | 15DAA1 | 60 | 39.2 | 22.5 | 0.0 | 25.0 | 39.2 |
| BRSOM | 15DAA1 | 60 | 39.2 | 360.0 | 0.0 | 5.0 | 39.2 |
| BRSOM | 15DAA1 | 60 | 39.2 | 45.0 | 0.0 | 15.0 | 39.2 |
| BRSOM | 15DAA1 | 60 | 39.2 | 90.0 | 0.0 | 15.5 | 39.2 |
| BRSOM | 15DAA1 | 60 | 38.6 | 180.0 | 0.0 | 16.6 | 38.6 |
| BRSOM | 15DAA1 | 60 | 38.6 | 22.5 | 0.0 | 29.6 | 38.6 |
| BRSOM | 15DAA1 | 60 | 38.6 | 360.0 | 0.0 | 12.8 | 38.6 |
| BRSOM | 15DAA1 | 60 | 38.6 | 45 | 0 | 22.6 | 38.6 |
| BRSOM | 15DAA1 | 60 | 38.6 | 90 | 0 | 22.7 | 38.6 |
| BRSOM | 28DAA1 | 60 | 25.3 | 360 | 0 | 6.7 | 25.3 |

TABLE 2
Reduction in % Visual Leafroll to BRSOM from Postemergence Applications
of Aminopyralid triisopropanolammonium (TIPA) + Clopyralid-
triisopropanolammonium (TIPA) in Pot Trials.

| | | | | | | Aminopyralid TIPA + | |
|---|---|---|---|---|---|---|---|
| | | | | | | Clopyralid TIPA | |
| | | Aminopyralid | | Clopyralid | | | Colby |
| | | TIPA | | TIPA | | Observed | Predicted |
| Crop | | | Mean % | | Mean % | Mean % | Mean % |
| Bayer | Evaluation | g | Visual | g | Visual | Visual | Visual |
| Code | Interval | ae/ha | Leafroll | ae/ha | Leafroll | Leafroll | Leafroll |
| BRSOM | 1DAA1 | 60 | 1.5 | 360 | 0.0 | 0.0 | 1.5 |
| BRSOM | 1DAA1 | 60 | 5.5 | 180 | 0.0 | 1.0 | 5.5 |
| BRSOM | 1DAA1 | 60 | 5.5 | 360 | 0.0 | 0.0 | 5.5 |
| BRSOM | 1DAA1 | 60 | 5.5 | 90 | 0.0 | 1.0 | 5.5 |
| BRSOM | 4DAA1 | 60 | 7.1 | 180 | 0.0 | 1.9 | 7.1 |
| BRSOM | 4DAA1 | 60 | 7.1 | 90 | 0.0 | 1.0 | 7.1 |
| BRSOM | 15DAA1 | 60 | 20.0 | 180 | 0.0 | 6.8 | 20.0 |
| BRSOM | 15DAA1 | 60 | 20.0 | 360 | 0.0 | 5.3 | 20.0 |
| BRSOM | 15DAA1 | 60 | 20.0 | 90 | 0.0 | 10.8 | 20.0 |
| BRSOM | 15DAA1 | 60 | 26.3 | 180 | 0.0 | 14.9 | 26.3 |
| BRSOM | 15DAA1 | 60 | 26.3 | 360 | 0.0 | 13.1 | 26.3 |
| BRSOM | 15DAA1 | 60 | 26.3 | 90 | 0.0 | 18.9 | 26.3 |
| BRSOM | 28DAA1 | 60 | 14.2 | 360 | 0.0 | 3.3 | 14.2 |

TABLE 3
Reduction in Percent (%) Visual Injury to BRSSS from Postemergence
Applications of Aminopyralid-triisopropanolammonium (TIPA) +
Clopyralid-triisopropanolammonium (TIPA) in Pot Trials.

| | | | | | | Aminopyralid TIPA + | |
|---|---|---|---|---|---|---|---|
| | | | | | | Clopyralid TIPA | |
| | | Aminopyralid | | Clopyralid | | | Colby |
| | | TIPA | | TIPA | | Observed | Predicted |
| Crop | | | Mean % | | Mean % | Mean % | Mean % |
| Bayer | Evaluation | g | Visual | g | Visual | Visual | Visual |
| Code | Interval | ae/ha | Injury | ae/ha | Injury | Injury | Injury |
| BRSSS | 3DAA1 | 60 | 6.8 | 90 | 2.2 | 5.8 | 8.8 |
| BRSSS | 7DAA1 | 60 | 9.6 | 90 | 0.4 | 1.6 | 10.0 |
| BRSSS | 15DAA1 | 60 | 15.4 | 90 | 0.0 | 4.6 | 15.4 |
| BRSSS | 28DAA1 | 60 | 15.6 | 90 | 0.0 | 8.8 | 15.6 |

### Example 2. Evaluation of Postemergence Herbicidal Safening of Aminopyralid in Brassica Species

Two field trials were established in Canterbury, New Zealand to evaluate crop safety of herbicide treatments to leafy forage brassica crops (Aparima Gold swede (Brassica sp., BRSSS)). Trials were designed as randomized complete blocks with four replicates. All trials were established as weed-free tolerance trials with plot size of 3 meters (m) by 8 m (width x length). The crops were grown using normal cultural practices for fertilization, seeding, and maintenance to ensure good growth of the crop.

All herbicide treatments were applied post-emergence with applications made to the crops at the 3 to 5-leaf stage. Herbicides were applied with backpack sprayers using carbon dioxide (CO2) as a propellant. The sprayers utilized flat fan spray nozzles calibrated to deliver a uniform spray pattern that provided thorough coverage of the foliage using a 187 L/ha spray volume. All treatments were applied with Uptake adjuvant (paraffinic oil/Non-Ionic Surfactant blend) at 1% v/v. Phytotoxicity to the crops was assessed visually at several intervals after application as percent overall injury, compared to an untreated control plot.

The overall injury assessments were based on visual ratings of growth inhibition, leaf deformity, epinasty, and chlorosis. All treatment results, both for the single product and mixtures, are an average of five replicates.

Herbicide Treatments

Aminopyralid-TIPA was applied as Tordon™ Max Herbicide (30 g ae/L SL), and clopyralid-TIPA was applied as Versatill™ (300 g ae/L SL),

The compositions tested, application rates employed, plant species tested, and results are given in Table 4 and Table 5.

TABLE 4
Reduction in Percent (%) Visual Injury to BRSSS from Postemergence
Applications of Aminopyralid-triisopropanolammonium (TIPA) +
Clopyralid-triisopropanolammonium (TIPA) in Field Trials.

| | | | | | | Aminopyralid TIPA + | |
|---|---|---|---|---|---|---|---|
| | | | | | | Clopyralid TIPA | |
| | | Aminopyralid | | Clopyralid | | | Colby |
| | | TIPA | | TIPA | | Observed | Predicted |
| Crop | | | Mean % | | Mean % | Mean % | Mean % |
| Bayer | Evaluation | g | Visual | g | Visual | Visual | Visual |
| Code | Interval | ae/ha | Injury | ae/ha | Injury | Injury | Injury |
| BRSSS | 13DAA1 | 60 | 22.5 | 180 | 2.3 | 11.3 | 24.2 |
| BRSSS | 13DAA1 | 60 | 22.5 | 45 | 0.8 | 17.5 | 23.1 |
| BRSSS | 22DAA1 | 60 | 28.8 | 45 | 0.0 | 20.5 | 28.8 |
| BRSSS | 28DAA1 | 60 | 38.8 | 180 | 3.0 | 27.5 | 40.6 |

TABLE 5
Reduction in % Visual Growth Inhibition to BRSSS from Postemergence
Applications of Aminopyralid triisopropanolammonium (TIPA) +
Clopyralid-triisopropanolammonium (TIPA) in Field Trials.

| | | | | | | Aminopyralid TIPA + | |
|---|---|---|---|---|---|---|---|
| | | Aminopyralid | | | | Clopyralid TIPA | |
| | | TIPA | | Clopyralid | | | Colby |
| | | | Mean % | TIPA | | Observed | Predicted |
| Crop | | | Visual | | Mean % | Mean % | Mean % |
| Bayer | Evaluation | g | Growth | g | Growth | Growth | Growth |
| Code | Interval | ae/ha | Inhibition | ae/ha | Inhibition | Inhibition | Inhibition |
| BRSSS | 13DAA1 | 60 | 28.8 | 180 | 7.5 | 20.0 | 34.1 |
| BRSSS | 13DAA1 | 60 | 28.9 | 45 | 2.8 | 18.8 | 30.7 |
| BRSSS | 13DAA1 | 60 | 28.8 | 90 | 8.8 | 21.3 | 35.0 |
| BRSSS | 28DAA1 | 60 | 45.0 | 180 | 3.8 | 31.3 | 47.4 |
| BRSSS | 56DAA1 | 60 | 8.8 | 45 | 6.0 | 5.5 | 14.2 |

### Example 3. Evaluation of Postemergence Herbicidal Safening of Aminopyralid in Brassica Species

Field trials were established in Canada (in Manitoba, Alberta, and Saskatchewan) to evaluate crop safety of herbicide treatments to Spring Argentine canola (Brassica napus, BRSNS). Trials were designed as randomized complete blocks with four replicates. Trials were established as weed-free crop tolerance trials with plot sizes of 2-3 meters (m) by 8-25 m (width×length). The crops were grown using normal cultural practices for fertilization, seeding, and maintenance to ensure good growth of the crop.

All herbicide treatments were applied post-emergence to Nex 1012 glyphosate-tolerant canola (at the B12-B17 stage in the spring to early summer Herbicides were applied with bicycle or tractor-mounted sprayers using carbon dioxide (CO2) as a propellant. The sprayers delivered a uniform spray pattern that provided thorough coverage of the foliage using a 100 L/ha spray volume. All treatments were applied with glyphosate-dimethylammonium (450 g ae/ha) to maintain weed-free trials and to provide uniform adjuvancy for all treatments. Phytotoxicity to the canola was assessed visually at several intervals after application as percent overall injury, compared to an untreated control plot. The overall injury assessments were based on visual ratings of growth inhibition, leaf deformity, epinasty, chlorosis and delay in maturity. Assessments were made at 8-10 dayst after treament (DAT) for an initial rating, 14-17 DAT for an early-season rating, 28-32 DAT for a mid-season rating, and 42-55 DAT for a late-season rating.

Herbicide Treatments

Aminopyralid-triisopropanolammonium (TIPA) was applied as Milestone (240 g ae/L SL); clopyralid-olamine was applied as Lontrel™ 360 (360 g ae/L SL); and glyphosate-dimethylammonium was applied as Vantage™ XRT(480 g ae/L SL).

The compositions tested, application rates employed, plant species tested, and results are given in Table 5.

TABLE 5
Reduction in % Visual Injury to BRSNS-RR from Postemergence Applications of Aminopyralid
triisopropanolammonium (TIPA) + Clopyralid-olamine in Field Trials.

| | | | | | | | | Aminopyralid- | | | | | | |
|---|---|---|---|---|---|---|---|---|---|---|---|---|---|---|
| | | | | | | | | TIPA + | | | | | | |
| | Aminopyralid- | Gly- | | Mean % Visual Injury | | | | Clopyralidola- | Gly- | | Mean % Visual Injury | | | |
| Crop | TIPA | phosate | | Initial | Early | Mid | Late | mine | phosate | | Initial | Early | Mid | Late |
| Bayer | g | Formu- | | (8-10 | (14-17) | (28-32 | (42-55 | g | Formu- | | (8-10 | (14-17) | (28-32 | (42-55 |
| Code | ae/ha | lation | Rate | DAT) | DAT | DAT) | DAT) | ae/ha | lation | Rate | DAT) | DAT | DAT) | DAT) |
| BRSNS- | 10 | Gly- | 450 g | 2.8 | 1.9 | 2.3 | 1.5 | 10 + 46 | Gly- | 450 g | 1.8 | 2.1 | 2.3 | 0.4 |
| RR | | phosate- | ae/ha | | | | | | phosate- | ae/ha | | | | |
| | | DMA | | | | | | | DMA | | | | | |
| BRSNS- | 20 | Gly- | 450 g | 5 | 5 | 5.6 | 0.6 | 20 + 92 | Gly- | 450 g | 2.1 | 1.9 | 2.4 | 0.3 |
| RR | | phosate- | ae/ha | | | | | | phosate- | ae/ha | | | | |
| | | DMA | | | | | | | DMA | | | | | |
| BRSNS- | 0 | Gly- | 450 g | 1 | 0.4 | 1.5 | 0.2 | 0 | — | — | — | — | — | — |
| RR | | phosate- | ae/ha | | | | | | | | | | | |
| | | DMA | | | | | | | | | | | | |

| | | | | | | | Aminopyralid- | | | | | |
|---|---|---|---|---|---|---|---|---|---|---|---|---|
| | | Gly- | | | | | TIPA + | Gly- | | | | |
| | Aminopyralid- | phosate- | Mean % Visual Injury | | | | Clopyralidola- | phosate- | Mean % Visual Injury | | | |
| Crop | TIPA | DMA | Initial | Early | Mid | Late | mine | DMA | Initial | Early | Mid | Late |
| Bayer | g | g | (8-10 | (14-17) | (28-32 | (42-55 | g | g | (8-10 | (14-17) | (28-32 | (42-55 |
| Code | ae/ha | ae/ha | DAT) | DAT | DAT) | DAT) | ae/ha | ae/ha | DAT) | DAT | DAT) | DAT) |
| BRSNS- | 10 | 450 | 2.8 | 1.9 | 2.3 | 1.5 | 10 + 46 | 450 | 1.8 | 2.1 | 2.3 | 0.4 |
| RR | | | | | | | | | | | | |
| BRSNS- | 20 | 450 | 5 | 5 | 5.6 | 0.6 | 20 + 92 | 450 | 2.1 | 1.9 | 2.4 | 0.3 |
| RR | | | | | | | | | | | | |
| BRSNS- | 0 | 450 | 1 | 0.4 | 1.5 | 0.2 | 0 | 450 | — | — | — | — |
| RR | | | | | | | | | | | | |

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A method for safening Brassica species susceptible to injury from aminopyralid, comprising applying to the Brassica species, contacting the vegetation, or area adjacent thereto with a herbicidal composition comprising:
(a) a herbicidally effective amount of aminopyralid, or an agriculturally acceptable salt or ester thereof; and
(b) clopyralid or an agriculturally acceptable salt, ester, or combination thereof.

2. The method of claim 1, wherein the (a) and (b) are applied pre-emergently to the Brassica species or the undesirable vegetation.

3. The method of claim 1, wherein the (a) and (b) are applied post-emergently to the Brassica species or the undesirable vegetation.

4. The method of claim 1, wherein (a) is aminopyralid-triisopropanolamine (TIPA).

5. The method of claim 1, wherein (a) is aminopyralid-potassium.

6. The method of claim 1, wherein (b) is clopyralid-triisopropanolamine (TIPA).

7. The method of claim 1, wherein (b) is clopyralid-olamine

8. The method of claim 1, wherein the weight ratio of (a) to (b) is from 1:224 to 16.7:1.

9. The method of claim 1, wherein the weight ratio of (a) to (b) is from 1:90 to 6.7:1.

10. The method of claim 1, wherein the weight ratio of (a) to (b) is from 1:6 to 2.7:1.

11. The method of claim 1, wherein the safened herbicidal composition further comprises an agriculturally acceptable adjuvant or carrier.

12. The method of claim 1, wherein the Brassica species is 5-enolpyruvylshikimate-3-phosphate (EPSP) synthase inhibitor-tolerant, glutamine synthetase inhibitor-tolerant, synthetic auxin-tolerant, acetyl CoA carboxylase (ACCase) inhibitor-tolerant, acetolactate synthase (ALS) inhibitor-tolerant, 4-hydroxyphenyl-pyruvate dioxygenase (HPPD) inhibitor-tolerant, protoporphyrinogen oxidase (PPO) inhibitor-tolerant, or photosystem II inhibitor-tolerant.

13. The method of claim 1, wherein the Brassica species comprises multiple or stacked traits conferring tolerance to multiple chemistries and/or multiple modes of action.
